(19) United States
(12) Patent Application Publication
(10) Pub. No.: US 2008/0132204 A1
(43) Pub. Date: Jun. 5, 2008

(54) SYSTEM AND METHOD FOR UPDATING AT LEAST ONE ATTRIBUTE STORED AT A MOBILE STATION

(75) Inventors: RYAN P. ZIOLKO, SCHAUMBURG, IL (US); STANLEY J. KNAPCZYK, JUSTICE, IL (US); CHRIS A. KRUEGEL, PLAINFIELD, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/566,401

(22) Filed: Dec. 4, 2006

(51) Int. Cl. H04M 1/66

(52) U.S. Cl. 455/411

(57) ABSTRACT

A method for updating at least one attribute stored at a mobile station comprises determining a mobile station hash that is representative of a set of attributes that is currently stored at the mobile station and determining a desired hash that is representative of a set of desired attributes desired to be stored at the mobile station. The method additionally includes comparing the mobile station hash with the desired hash, and updating at least one attribute in the set of attributes that is currently stored at the mobile station when the mobile station hash is not equal to the desired hash.

### TECHNICAL FIELD OF THE DISCLOSURE

The present disclosure relates to a system and method for updating at least one attribute at a mobile station.

### BACKGROUND OF THE DISCLOSURE

Communication systems, including radio transceivers, are common and are often used in emergency communication situations. Often, these communication systems use encryption techniques for secure communications, although not all systems are secure. For example, Motorola, Inc. offers a line of secure communication systems as the ASTRO system. In a typical secure communications system, transmissions between a base station and a mobile station, such as between a dispatch and an ambulance or fire engine, are encrypted with a changing set of encryption keys or other attributes. To provide additional levels of security, the attributes stored at a mobile station can change and be modified with a rekeying process. Other communication systems can update various parameters, including software updates and the like, using over the air protocols as well. In the event that the mobile station does not have the current set of attributes stored, communications can be undesirably delayed. In response, several rekeying (or attribute update) solutions have been proposed.

One solution propagates attribute changes with multiple transmissions over the system. While effective, such propagation undesirably occupies available bandwidth, potentially delaying communications. Another solution includes a complete transmission of all attributes held by the base station. Again, while effective, such a solution undesirably occupies available bandwidth.

In some systems, attribute updates are performed with a direct, wired, connection between the mobile station and the base station. In other systems, rekeying is provided using an over the air rekeying (“OTAR”) process in which a key management facility (“KMF”) at the base station manages the encryption keys and related attributes for the mobile stations. While OTAR is effective, in the event that a mobile station is either out of range of the OTAR transmissions, or does not receive the OTAR (e.g., the mobile station is powered off, in a tunnel, in an urban canyon, etc.), the set of attributes stored at the mobile station can be out-of-date.

In other systems, updates are provided using an over the air programming (“OTAP”) process in which the base station manages the programming of the mobile stations. While OTAP is effective, in the event that a mobile station is either out of range of the OTAP transmissions, or does not receive the OTAP (e.g., the mobile station is powered off, in a tunnel, in an urban canyon, etc.), the set of attributes stored at the mobile station can be out-of-date.

Further, in some systems, a user can intentionally or unintentionally alter the set of attributes stored at the mobile station which could also render the set of attributes stored at the mobile station out-of-date or inaccurate as well. For example, some systems allow the user the ability to change keys or other stored attributes using the keypad or other user input device on the mobile station.

Moreover, other OTAR/OTAP systems update each key or attribute during a given period (e.g., each encryption period), thus producing a large body of duplicative data traffic, and reducing the effective bandwidth of the communication system. Some OTAR techniques are also classified as store and forward (“SAF”). In a SAF system, a mobile station or a key fill device (KFD) receives at least one attribute, stores the received attribute, and forwards the received and stored attribute to at least one additional mobile station. Such a system can reduce transactions at the base station, but increases traffic among mobile stations.

Therefore, it would be desirable to provide a system and method for updating at least one attribute at a mobile station that overcomes the aforementioned disadvantages.

### BRIEF DESCRIPTION THE FIGURES

Various embodiments of the disclosure are now described, by way of example only, with reference to the accompanying figures, in which:

FIG. 1 is a block diagram of a plurality of mobile stations in wireless communication with a base station in accordance with the present disclosure;

FIG. 2 is a flowchart of a first example of a method for updating at least one attribute in the set of attributes stored at the mobile station in accordance with the present disclosure; and

FIG. 3 is a flowchart of a second example of a method for updating at least one attribute in the set of attributes stored at the mobile station in accordance with the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE DISCLOSURE

A system and method for updating at least one attribute stored at a mobile station in a wireless communication system is disclosed. In the present disclosure, communication bandwidth usage between a base station and a mobile station is reduced when updating at least one attribute stored at a mobile station by use of hash functions (or hash algorithms). Hash functions are commonly known in a general sense and are used as a shortcut for comparing two data strings. A hash function is a way of creating a small digital “fingerprint” from stored data (for example, from encryption key data or other attribute data). This fingerprint is generally represented as a short string of random-looking letters and/or numbers. The hashing techniques, or algorithms, used in the methods disclosed herein, for example, substitute or transpose attribute data (currently stored at the mobile station or desired to be stored at the mobile station) to create a hash as the output of the hashing technique.

In accordance with the present disclosure, a first hash function is determined to represent a set of desired attributes to be stored at a mobile station and a second hash function is determined to represent a set of attributes currently stored at the mobile station. The resultant hashes are compared, and based on the results of the comparison, the set of attributes stored at the mobile station may or may not be updated or, if updated, the entire set of desired attributes may not need to be transmitted in its entirety in order to bring the attributes stored at the mobile station up-to-date.

The set of attributes (and/or the desired set of attributes) may include, but is not limited to, encryption keys, encryption state variables, encryption identifiers, encryption configuration attributes, programmed channels, software modules, stored identification as well as any other attribute at the mobile station that is managed or configured by the base station. The base station generates the set of desired attributes that each mobile station is desired to have that represents the most current attribute data for the mobile station. The set of desired attributes can be generated via memory or generated or received from an external source. Let us now refer to the figures and describe the present disclosure in greater detail.

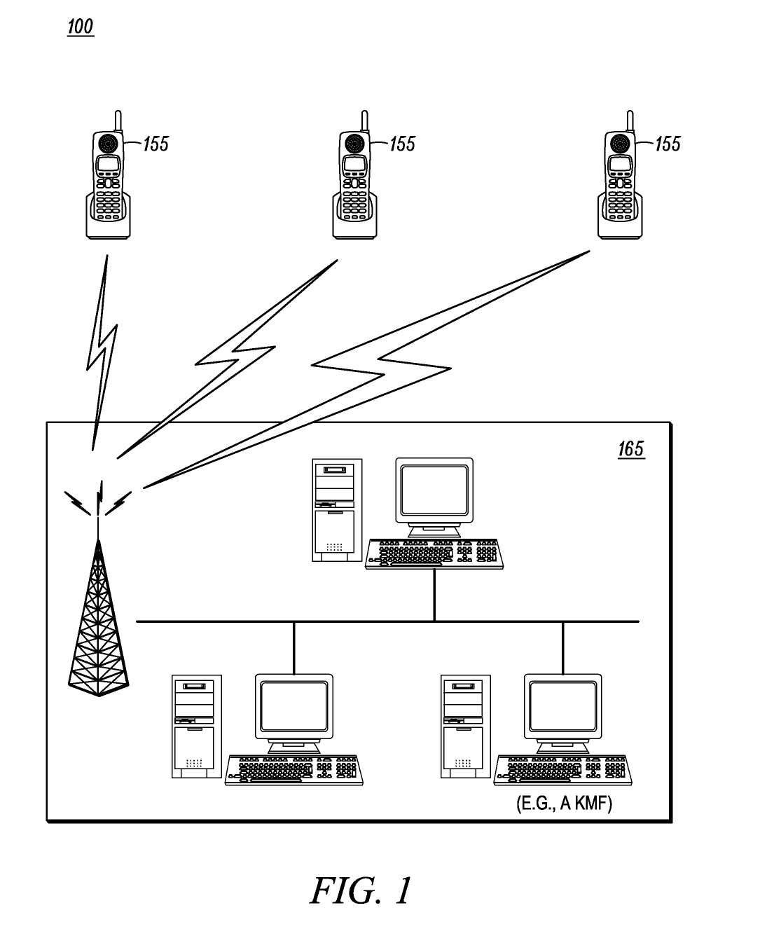

FIG. 1 illustrates one embodiment of a communication system 100 in accordance with the present disclosure. The communication system 100 includes at least one mobile station 155 in wireless communication with a base station 165. A mobile station 155 is any device configured for wireless communication with at least one of a base station 165 and other mobile stations 155. The base station 165 is a communication terminal configured for wireless communication with at least one additional base station 165 and/or at least one mobile station 155. The base station 165 can be implemented as any number of communication terminals, linked or unlinked. Each communication terminal can further be connected to other communication devices, such as computers. For example, the base station 165 can be implemented at a dispatch center and/or a key management center, such as a 911 center, fire station, hospital, police station, crisis management center or the like. The mobile station 155 and the base station 165 comprise commonly known components, including circuitry for transmitting and/or receiving communications (secure communications, non-secure communications, or both) to and/or from the base station 165 and/or mobile stations 155, and circuitry for generating and/or determining hashes. Various combinations of the hardware components for the mobile station 155 and the base station 165 are commonly known to those of ordinary skill in the art, and will not be discussed in detail in this disclosure in order to not depart from the spirit and scope of the present disclosure.

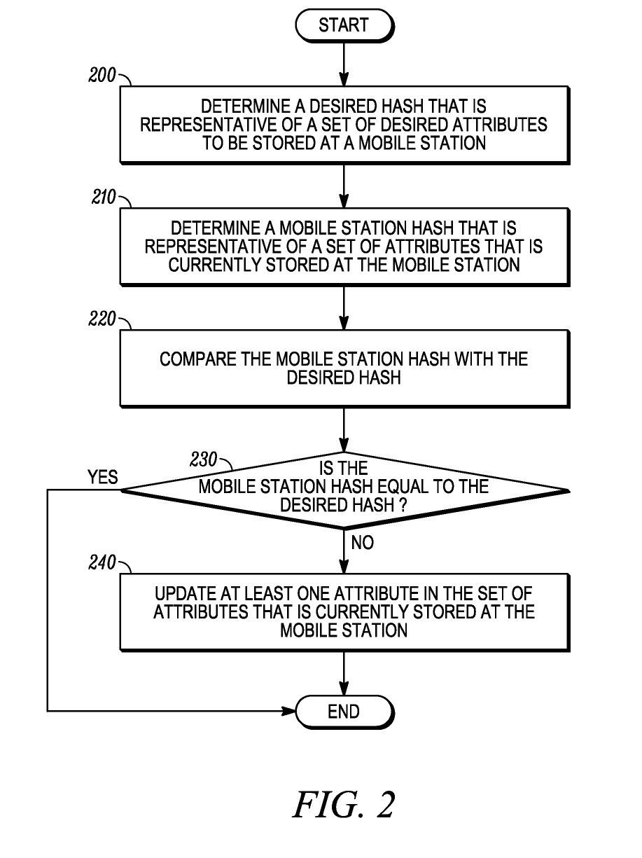

FIG. 2 is a flowchart of a method for updating at least one attribute stored at a mobile station 155 in accordance with the present disclosure. It is important to note that the mobile station 155, the base station 165 or a combination of both can perform the steps of FIG. 2 as will be described in more detail below. In accordance with the present disclosure, a desired hash is determined that is representative of a set of desired attributes to be stored at the mobile station 155 at step 200. The desired hash can be determined using any appropriate hashing technique such as Message-Digest algorithms (i.e., MD-2, MD-4, MD-5, etc.), WHIRLPOOL, SHA-1, RACE Integrity Primitives Evaluation Message Digest (“RIPEMD”), or the like. The desired hash is generated by the base station 165; the desired hash, however, can be “determined” by either the base station 165 or the mobile station 155. For example, the base station 165 can determine the desired hash from its memory, whereas the mobile station 155 can determine the desired hash by receiving a message from the base station 165 and extracting the desired hash from the message (e.g., extracting the desired hash from the message header, extracting the desired hash from the body of the message, or the like).

In addition to the desired hash, a mobile station hash that is representative of a set of attributes that is currently stored at the mobile station is determined at step 210. As with the desired hash, the mobile station hash can be determined using any appropriate hashing technique as commonly known in the art, such as Message-Digest algorithms (i.e., MD-2, MD-4, MD-5, etc.), WHIRLPOOL, SHA-1, RACE Integrity Primitives Evaluation Message Digest (“RIPEMD”), or the like. Further, the mobile station hash can be determined by the mobile station itself 155 or by the base station 165. For example, the mobile station hash can be determined from a memory stored at the mobile station 155 or a memory stored at the base station 165; the mobile station hash can be determined by the base station 165 by querying the mobile station 155 for its mobile station hash and receiving the mobile station hash from the mobile station 155; or the mobile station hash can be determined by the base station 165 from an unsolicited message received at the base station 165 from the mobile station 155 (e.g., a registration message, a rekey request message, a hello message. a poll message, or the like). It should be noted that there will be other ways that the mobile station hash can be determined by the mobile station 155 or by the base station 165 that will become obvious to a person of ordinary skill in the art after reading the present disclosure.

Once the desired hash and the mobile station hash have been determined, the hashes are compared to each other to determine the difference, if any, at step 220. The comparison can occur at either the mobile station 155 or the base station 165. If the mobile station hash is equal to the desired hash at step 230, there is no need for the attributes stored in the mobile station 155 to be updated because the set of attributes stored in the mobile station 155 is up-to-date. Thus, over-the-air bandwidth and resources are preserved because the base station 165 does not need to update the mobile station 155 with the most current set of attributes. In one embodiment, if the mobile station hash is equal to the desired hash at step 230, the process ends until the base station needs to update a stored attribute, until a predetermined amount of time lapses, or until some other triggering event occurs; in another embodiment, however, depending on which device is performing the comparison of the hashes, the base station 165 can send the mobile station 155 a message indicating that the attributes stored at the mobile station 155 are up-to-date, or the mobile station 155 can send the base station 165 a message indicating that the attributes stored at the mobile station 155 are up-to-date.

If, on the other hand, the mobile station hash is not equal to the desired hash at step 230, at least one attribute in the set of attributes stored at the mobile station is updated at step 240. It should be noted that a plurality of messages may need to be sent in order to update the at least one attribute in the set of attributes stored at the mobile station, depending on the size of the set of desired attributes being sent to the mobile station and/or depending on which technique is used to update the set of attributes stored at the mobile station 155.

There are numerous ways that the at least one attribute in the set of attributes stored at the mobile station is updated. It should be noted that the following examples should not be considered limiting in nature, and that there will be other ways that the at least one attribute in the set of attributes stored at the mobile station is updated that will become obvious to a person of ordinary skill in the art after reading the present disclosure. In a first example, if the base station 165 performs the comparison, the base station 165 can automatically begin updating the attributes stored at the mobile station 155 by sending the entire set of desired attributes to the mobile station 155 when it is determined that the hashes are not equal by using commonly known techniques, such as OTAR, OTAP, store-and-forward, or the like.

In a second example, if the base station 165 performs the comparison, the base station 165 can automatically send a first portion of the set of desired attributes to the mobile station 155 when it is determined that the hashes are not equal. The mobile station 155 processes the first portion of the set of desired attributes and generates a new mobile station hash. The base station 165 receives and compares the new mobile station hash with the desired hash. If the hashes still do not match, the base station sends a next portion of the set of desired attributes. This process of receiving a new mobile station hash, comparing the new mobile station hash with the desired hash, and sending a next portion of the set of desired attributes continues until the hashes are equal.

In a third example, if the mobile station 155 performs the comparison, the mobile station 155 can request that the base station 165 send the entire set of desired attributes to the mobile station 155 when it is determined that the hashes are not equal.

In a fourth example, if the mobile station 155 performs the comparison, the mobile station 155 can request a first portion of the set of desired attributes from the base station 165. Once received and processed, the mobile station 155 generates a new mobile station hash and compares the new mobile station hash with the desired hash. If the new mobile station hash still does not equal the desired hash, the mobile station 155 requests a next portion of the set of desired attributes from the base station 165. The mobile station 155 continues requesting updates, processing the portions of the set of desired attributes, and generating a new mobile station hash until the new mobile station hash equals the desired hash.

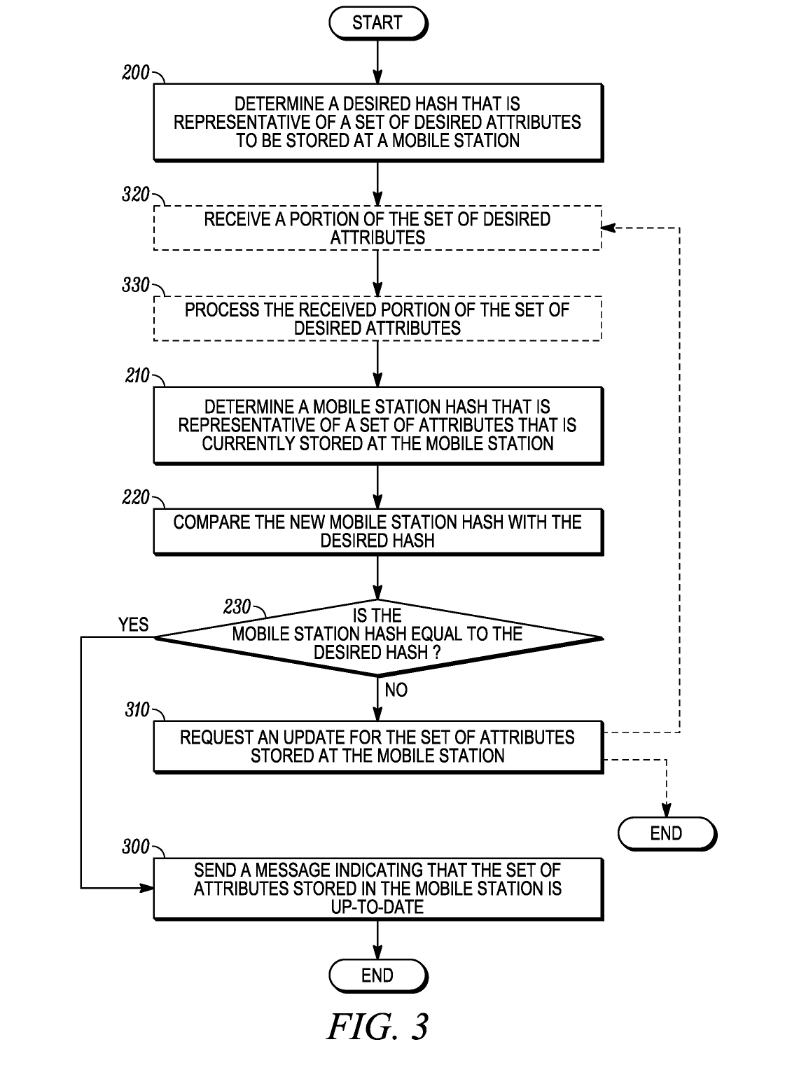

To provide additional details regarding updating at least one attribute stored at the mobile station when the set of desired attributes are sent in a plurality of messages, let us refer to FIG. 3 and describe a first example of the operation of the mobile station in accordance with the present disclosure. It should be noted that there are some overlapping steps between FIG. 2 and FIG. 3, and where appropriate, like reference numerals are used. In this example, as in FIG. 2, a desired hash is determined that is representative of a set of desired attributes to be stored at the mobile station 155 at step 200. In addition to the desired hash, a mobile station hash that is representative of a set of attributes that is currently stored at the mobile station is determined at step 210. Once the desired hash and the mobile station hash have been determined, the hashes are compared to each other to determine the difference, if any, at step 220. If the mobile station hash is equal to the desired hash at step 230, there is no need for the set of attributes stored at the mobile station 155 to be updated because the set of attributes stored at the mobile station 155 is up-to-date. In this example, since the mobile station is performing the comparison step 230, the mobile station 155 sends the base station 165 a message indicating that the set of attributes stored at the mobile station 155 is up-to-date at step 300. If, however, the mobile station hash is not equal to the desired hash at step 230, the mobile station 155 requests an update for the set of attributes stored at the mobile station 155 from the base station 165 at step 310. Again, as noted above, depending on the software configuration of the communication system 100, the request for an update can result in the base station 165 sending the mobile station 155 the entire set of desired attributes to be stored at the mobile station 155, in which case, the mobile station 155 processes and stores the entire set of desired attributes to be stored resulting in the mobile station 155 being up-to-date.

Alternatively, when the mobile station 155 requests an update for the set of attributes stored at the mobile station 155 from the base station 165 at step 310, the communication system 100 can be configured to have the mobile station 155 receive and process a portion of the set of desired attributes to be stored at the mobile station 155 from the base station 165 at steps 320 and 330. Once the portion of the set of desired attributes to be stored at the mobile station 155 is processed, the process loops back to step 210 and a new mobile station hash is determined. The new mobile station hash and the desired hash are compared at step 220. This is an iterative process until the new mobile station hash equals the desired hash at step 230, at which time, in this specific example, the mobile station 155 sends a message to the base station 165 indicating that the set of attributes stored at the mobile station 155 is up-to-date. It should be noted that the iterative process in FIG. 3 is only repeated until the set of desired attributes have been sent to the mobile station 155 in its entirety a predetermined number of times (for example, 1 time, 2 times . . . n times) before the process is terminated in order to prevent an infinite loop. If the process is forced to be terminated, the system administrator may be notified to take a closer look at the particular mobile station 155 to troubleshoot the problem and/or determine whether the particular mobile station 155 has been illegally tampered with or altered.

The process described above with respect to FIG. 3 can further be modified by having the mobile station automatically receive and process a portion of the set of desired attributes to be stored at the mobile station 155 before the mobile station hash is determined (steps 320 and 330). In this modified scenario, the mobile station 155 determines the desired hash, for example, from a message received from the base station 165. Also included in the message, or included in another message, the mobile station 155 receives and processes a portion of the set of desired attributes to be stored at the mobile station 155 at steps 320 and 330. The process continues as described above with the mobile station determining its mobile station hash at step 210. It should be noted that in this modified scenario for FIG. 3, the step of processing the portion of the set of desired attributes to be stored at the mobile station 155 can occur before or after the mobile station determines its mobile station hash at step 210. Thus, in one scenario, the mobile station determines the desired hash in step 200 and receives a portion of the set of desired attributes to be stored at the mobile station 155 at step 320 in a single message. The mobile station 155 determines its mobile station hash and compares the mobile station hash with the desired hash at steps 210 and 220, respectively. If the mobile station hash does not equal the desired hash, only then does the mobile station 155 process the portion of the set of desired attributes to be stored at the mobile station 155 received at step 320. Once processed, the process loops back to step 210 to determine a new mobile station hash that takes into account the processing of the portion of the set of desired attributes to be stored at the mobile station 155.

In various embodiments of the disclosure, the mobile station hash can further be generated in response to a request from the base station 165, and the desired hash can be generated in response to a request from the mobile station 155. When inconsistent attributes are found, any of the methods can undergo further authentication prior to simply updating a mobile station 155 to allow communication with the base station 165. Further, updating can include rekeying each encryption key, only rekeying any mobile station attributes that are determined to be inconsistent, updating a portion of a software upgrade, updating an entire software upgrade, or the like.

It is important to note that the figures and description illustrate specific applications and embodiments of the present disclosure, and is not intended to limit the scope of the present disclosure or claims to that which is presented therein. Upon reading the specification and reviewing the drawings hereof, it will become immediately obvious to those skilled in the art that myriad other embodiments of the present disclosure are possible, and that such embodiments are contemplated and fall within the scope of the presently claimed disclosure.

Various changes and modifications can be made without departing from the spirit and scope of the disclosure. The scope of the disclosure is indicated in the appended claims, and all changes that come within the meaning and range of equivalents are intended to be embraced therein.

We claim:

1. A method for updating at least one attribute stored at a mobile station, the method comprising the steps of:
determining a desired hash that is representative of a set of desired attributes to be stored at the mobile station;
determining a mobile station hash that is representative of a set of attributes that is currently stored at the mobile station;
comparing the mobile station hash with the desired hash; and
updating at least one attribute in the set of attributes that is currently stored at the mobile station when the mobile station hash is not equal to the desired hash.

2. The method of claim 1 further comprising the step of sending a message indicating that the set of attributes stored in the mobile station is up-to-date when the mobile station hash is equal to the desired hash.

3. The method of claim 1 wherein the step of updating is implemented via one of the group consisting of over-the-air rekeying (OTAR), over-the-air programming (OTAP), and store and forward.

4. The method of claim 1 wherein the set of attributes comprises at least one of the following: an encryption key, an encryption state variable, an encryption identifier, an encryption configuration attribute, a programmed channel, a software module, a key association, and a stored identification.

5. The method of claim 1 wherein the mobile station hash is determined from a memory stored at a base station.

6. The method of claim 1 wherein determining the mobile station hash includes the following steps:
querying the mobile station for the mobile station hash; and
receiving the mobile station hash from the mobile station.

7. The method of claim 1 wherein the mobile station hash is determined from an unsolicited message received from the mobile station.

8. The method of claim 7 wherein the unsolicited message is a registration message, a rekey request message, or a hello message.

9. The method of claim 1 wherein the step of comparing is performed at a base station.

10. The method of claim 1 wherein the step of comparing is performed at the mobile station.

11. A method for updating at least one attribute stored at a mobile station, the method comprising the steps of:
receiving a desired hash that is representative of a set of desired attributes to be stored at the mobile station;
generating a mobile station hash that is representative of a set of attributes that is currently stored at the mobile station;
comparing the desired hash with the mobile station hash;
if the mobile station hash is equal to the desired hash, sending a message indicating that the set of attributes stored at the mobile station is up-to-date; and
if the mobile station hash is not equal to the desired hash, requesting an update for the set of attributes stored at the mobile station.

12. The method of claim 11 wherein the update comprises a plurality of messages, and further comprising the steps of, when the mobile station hash is not equal to the desired hash:
receiving a portion of the update;
updating the set of attributes that is currently stored at the mobile station based on the portion of the update that is received;
generating a new mobile station hash that is representative of the set of attributes that is currently stored at the mobile station;
comparing the desired hash with the new mobile station hash; and
if the new mobile station hash is equal to the desired hash, sending a message to the base station indicating that the set of attributes that is currently stored at the mobile station is up-to-date; and
if the mobile station hash is not equal to the desired hash, requesting a next portion of the update.

13. The method of claim 12 wherein the steps of receiving a portion of the update, updating the set of attributes that is currently stored at the mobile station based on the portion of the update that is received, generating a new mobile station hash that is representative of the set of attributes that is currently stored at the mobile station, and comparing the desired hash with the new mobile station hash are repeated until the new mobile station hash is equal to the desired hash.

14. The method of claim 12 wherein the steps of receiving a portion of the update, updating the set of attributes that is currently stored at the mobile station based on the portion of the update that is received, generating a new mobile station hash that is representative of the set of attributes that is currently stored at the mobile station, and comparing the desired hash with the new mobile station hash are repeated until the update has been delivered in its entirety.

15. The method of claim 14 wherein the update comprises the set of desired attributes in its entirety.

16. The method of claim 14 wherein the update comprises a portion of the set of desired attributes.

17. The method of claim 12 wherein the portion of the update comprises the update in its entirety.

18. A method for updating at least one attribute stored at a mobile station, the method comprising the steps of:
receiving a desired hash that is representative of a set of desired attributes to be stored at the mobile station;
receiving a portion of the set of desired attributes;
processing the portion of the set of desired attributes;
generating a mobile station hash that is representative of a set of attributes that is currently stored at the mobile station;
comparing the desired hash with the mobile station hash;
if the mobile station hash is equal to the desired hash, sending a indication that the set of attributes stored at the mobile station is up-to-date; and
if the mobile station hash is not equal to the desired hash, requesting a next portion of the set of desired attributes.

19. The method of claim 18 further comprising the steps of, when the mobile station hash is not equal to the desired hash:
receiving the next portion of the set of desired attributes;
updating the set of attributes that is currently stored at the mobile station based on the next portion of the set of desired attributes that is received;
generating a new mobile station hash that is representative of the set of attributes that is currently stored at the mobile station;
comparing the desired hash with the new mobile station hash; and
if the new mobile station hash is equal to the desired hash, sending a message to the base station indicating that the set of attributes that is currently stored at the mobile station is up-to-date; and
if the mobile station hash is not equal to the desired hash, requesting an additional portion of the set of desired attributes.

20. The method of claim 19 wherein the steps of receiving the next portion of the set of desired attributes, updating the set of attributes that is currently stored at the mobile station based on the next portion of the set of desired attributes that is received, generating a new mobile station hash that is representative of the set of attributes that is currently stored at the mobile station, and comparing the desired hash with the new mobile station are repeated until the new mobile station hash is equal to the desired hash.

21. The method of claim 19 wherein the steps of receiving the next portion of the set of desired attributes, updating the set of attributes that is currently stored at the mobile station based on the next portion of the set of desired attributes that is received, generating a new mobile station hash that is representative of the set of attributes that is currently stored at the mobile station, and comparing the desired hash with the new mobile station are repeated until the set of desired attributes has been delivered in its entirety.

22. The method of claim 19 further comprising the step of receiving the desired hash with the next portion of the set of desired attributes.

22. The method of claim 20 further comprising the step of receiving the desired hash each time the next portion of the set of desired attributes is received.

24. The method of claim 21 further comprising the step of receiving the desired hash each time the next portion of the set of desired attributes is received.
